(19) United States
(12) Patent Application Publication
(10) Pub. No.: US 2026/0242606 A1
(43) Pub. Date: Aug. 20, 2026

(54) PROCESS OF PREPARATION OF RESIDUE FREE SOLVENT BLUE 67 DYE

(71) Applicant: RATHI DYE CHEM (P) LTD, Pune (IN)

(72) Inventor: Nilesh RATHI, Pune (IN)

(73) Assignee: RATHI DYE CHEM (P) LTD, Pune (IN)

(21) Appl. No.: 19/157,046

(22) PCT Filed: Feb. 17, 2024
(86) PCT No.: PCT/IN2024/050170

§ 371 Date: Aug. 15, 2025

(30) Foreign Application Priority Data
Feb. 18, 2023 (IN) 202321011087

(51) Int. Cl. C09B 47/20; C07F 1/08; C09B 67/54

(52) U.S. Cl. CPC C09B 47/20; C07F 1/08; C09B 67/0096

(57) ABSTRACT

The present invention relates to a process of preparation of Solvent Blue 67 dye for various applications like printing ink, stationery ink, wood stains, aluminium foil coloring, polyester and metals foils, glass, plastic and metal coatings, leather and plastic coloration/finishing, hot stamping foil coloring, etc The process (100) of the present invention includes a first stage of reaction with chlorosulfonic acid (110), a second stage of condensation reaction with alkyl/aryl/dialkyl/diaryl/hydroxylalkyl amine organocatalyst (120), a third stage of drying and sieving of the product (130), and a fourth stage of packing and dispatching of final product (140). The process (100) advantageously prepares a residue free Solvent Blue 67 dye and thereby ensures high quality printing and coloring process for various printing and coloring applications.

### FIELD OF THE INVENTION

The present invention relates to a process of preparation Solvent Blue 67 dye and more particularly to the process of preparation of residue free Solvent Blue 67 dye.

### BACKGROUND OF THE INVENTION

A dye is a colored substance that chemically binds with the substrate being applied to and imparts color to different substances or alters the color of something. Various types of dyes exist, solvent dyes being one of them. Solvent dyes are solvent soluble dyes of high quality for wide use in inks and coating industries. As they ensure superior solubility and stability in organic solvent systems, these dyes are usually used as a solution in an organic solvent to color organic solvents, hydrocarbon fuels, waxes, lubricants, plastics, and other hydrocarbon-based nonpolar materials. Solvent dyes are used in applications such as foil printing, printing inks, marking pens, ball point pens, candles and other waxes, polishes, leathers, wood stains, acrylic resins, varnishes, and shellacs. Names of solvent dyes are often generic, of the scheme “solvent”, e.g., Solvent Red 24, Solvent Red 26, Solvent Red 164, Solvent Yellow 124, Solvent Blue 35, Solvent Blue 67 etc.

Solvent Blue 67 belongs to the category of solvent dyes. Solvent Blue 67 is a metal complex blue colored phthalocyanine dye having CAS number 12226-78-7/81457-65-0, also known as Transparent Blue GN, AizenSpilon Blue GNH, Orasol Brilliant Blue GN, Filester Blue GN, Orasol Blue 825, Azosol Fast Blue HLR, Intraplast Brilliant Blue GN or Technosol Blue GN. The molecular weight of Solvent Blue 67 dye is in the range of 1253 to 1350 g/mol, and its molecular formula is C₅₆H₇₀N₁₂O₁₂S₄Cu or C₅₆H₇₂N₁₂O₁₃S₄Cu. The physical appearance of Solvent Blue 67 dye is greenish blue powder having good solubility, and good coloring value. Solvent Blue 67 is used in printing ink, stationery ink, wood stains, aluminum foil coloring, polyester & metals foils, glass, plastic & metal coatings, leather & plastic coloration/finishing, hot stamping foil coloring, etc.

The Japanese Patent Application JPH07268254A to Shimomura Tetsuo Guofeng and others describes a printing ink for an inkjet printer having fine resin particles containing Solvent Blue 67 as a dye in a finely dispersed aqueous medium. It described a process of dissolving 15 parts by weight of Solvent Blue 67 concrete cake at 80° C. and adding 600 parts of water at 80° C. to obtain an aqueous micro dispersion of a copolymer polyester resin having a particle size of about 0.15 μm.

The Chinese Patent Application CN103146254B to Mao Shunming and others discloses a preparation method of special phthalocyanine blue pigment from crude copper phthalocyanine for offset printing ink. It describes a process of dry milling the crude copper phthalocyanine in grinding equipment to prepare preactivated copper phthalocyanine with 20-40% a crystal form content. The preparation method includes steps such as ball milling, iron removal, and preparation of phthalocyanine blue.

One of the problems associated with the metal complex blue coloured phthalocyanine solvent dyes like Solvent Blue 67 is that they are insoluble in water and their residue in solvent solutions is high. Further, while using during various applications, the dye solution prepared is subjected to high temperature zone to fix it. The high evaporation rate of the solvents leads to solvent drying, clogging and residue formation. This causes trouble in printing, coating and coloring process for substrates like cans, bottles, metal, paper, etc.

Therefore, there is a need of a process for preparing residue free Solvent Blue 67 dye. There is also a need of the Solvent Blue 67 dye solution that prevents solvent dry clogging and residue formation, thus ensuring high quality printing, coating, and coloring processes.

### SUMMARY OF THE INVENTION

The present invention describes a process 100 for preparing Solvent Blue 67 dye. The first stage of reaction with chlorosulfonic acid 110 in the process 100 includes the steps of chlorosulfonation 201 followed by drowning 205, filtration 210 and homogenization 215. The second stage of condensation reaction with alkyl/aryl/dialkyl/diaryl/hydroxylalkyl amine organocatalyst 120 includes the steps of condensation 220 followed by clarification 225 and filtration 230. The third stage of retrieving of the product 130 includes spin flash drying 235 followed by air classifying 240 and sieving 245. The fourth stage of packing of final product 140 includes the steps of vibratory separation 250 followed by packing 255.

The first stage of reaction with chlorosulfonic acid 110 further includes the steps of chlorosulfonation 201 followed by drowning 205, filtration 210 and homogenization 215. The step of chlorosulphonation 201 reaction is carried out in a vessel by reacting predefined amount of chlorosulfonic acid with predefined amount of crude copper phthalocyanine blue in presence of predefined amount of specified catalyst.

The step of drowning 205 is carried out in a drowning vessel of chlorosulfonated mass prepared in the step of chlorosulfonation 201 in a predefined solution followed by quenching the drowning mass in ice water at a predefined temperature. The step of filtration 210 is carried out by filtering the chlorosulfonated mass drowned in the drowning 205 followed by washing with ice water at predefined pH. The step of homogenization 215 is carried out by charging the wet cake of the filtration 210 in the presence of predefined amount of ice in a re-slurry mixer at predefined temperature.

In the step of chlorosulphonation 201, the predefined amount of chlorosulfonic acid is 1200 g to 1400 g. The predefined amount of crude copper phthalocyanine blue is 220 g to 320 g, and the predefined catalyst like inorganic/organic acid chloride in an amount of 250 g to 380 g. In the step of drowning 205, the predefined solution is prepared from softening agent, catalyst, oxidant, and binders, and the quenching is carried out at a predefined temperature between near subzero to zero. In the step of filtration 210, the predefined pH is between 0.5 to 5.0. In the step of homogenization 215, the predefined amount of ice is 800 g-100 g and the predefined temperature is between near subzero or zero.

The second stage of condensation reaction with alkyl/aryl/dialkyl/diaryl/hydroxylalkyl amine organocatalyst 120 includes the steps of condensation 220 followed by clarification 225 and filtration 230. The step of condensation 220 is carried out by condensing chlorosulfonated slurry of homogenization 215 with solution of predefined amount of alkyl/aryl/dialkyl/diaryl/hydroxylalkyl amine organocatalyst and predefined amount of a predefined emulsifying agent in ice water at a predefined temperature and pH. The step of clarification 225 is carried out by circulating the reaction mass of condensation 220 in a filter of predefined mesh size for a predefined temperature. The step of filtration 230 is carried out by filtering the clarified slurry from the step of clarification 225 to attain a predefined conductivity.

In the step of condensation 220, the predefined amount of solution of alkyl/aryl/dialkyl/diaryl/hydroxylalkyl amine organocatalyst is 250 g to 400 g and the predefined emulsifying agent is selected from Noigen, Neowet Dainol Noigen, GMS, SLS and Linoxide in a predefined amount of 5 g to 15 g in ice water at a predefined temperature near subzero or zero and predefined pH is maintained at 8.0 to 10. In the step of clarification 225, the predefined mesh size of filter is 10 to 100 mesh, and the predefined temperature is 60° C. to 95° C. In the step of filtration 230, the clarified slurry is filtered to achieve a predefined conductivity of less than 20-200 μS.

The third stage of retrieving of the product 130 includes the steps of spin flash drying 235 followed by air classifying 240 and sieving 245. The step of spin flash drying 235 is carried out by drying the press cake obtained in filtration 230 by using turbo spin flash dryer. The step of air classifying 240 is carried out by passing the powder obtained in spin flash drying 235 through air classified mill. The step of sieving 245 is carried out by sieving of the dry powder obtained in air-classifying 240 over vibratory sieve fitted with sieve of predefined size. In the step of sieving 245, the predefined size of the vibratory sieve is 20 to 125 micron.

The fourth stage of packing of final product 140 includes the steps of vibratory separation 250 followed by packing 255. The step of vibratory separation 250 is carried out by separating the sieved powder obtained in sieving 245 by subjecting to vibration platform for separating the powder in the layers based on differential density. The step of packing 255 is carried out by packaging the residue free powder of the product Solvent Blue 67 obtained in vibratory separation 250.

The process 100 prepares a residue free Solvent Blue 67 dye and thereby ensures high quality printing and coloring process for various printing and coloring applications for substrates like cans, bottles, metal, and paper etc.

### BRIEF DESCRIPTION OF DRAWINGS

The objectives and advantages of the present invention will become apparent from the following description read in accordance with the accompanying drawings wherein,

FIG. 1 shows a plurality of stages involved in process of preparation of Solvent Blue 67 dye 100 in accordance with the present invention; and

FIGS. 2a and 2b show the comparison of the residue content of Solvent Blue 67 prepared by process of present invention and the conventional reference sample of Solvent Blue 67 available in market.

### DESCRIPTION OF THE INVENTION

References in the specification to “one embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

References in the specification to “preferred embodiment” means that a particular feature, structure, characteristic, or function described in detail thereby omitting known constructions and functions for clear description of the present invention.

The foregoing description of specific embodiments of the present invention has been presented for purposes of illustration and description. They are not intended to be exhaustive or to limit the present invention to the precise forms disclosed and obviously many modifications and variations are possible in light of the above teaching.

Solvent Blue 67 belongs to the category of solvent dyes. Solvent Blue 67 is metal complex blue colored phthalocyanine solvent soluble dye that ensures superior solubility in organic solvents. The molecules are typically nonpolar or less polar, and they do not undergo ionization. Solvent Blue 67 dye is used as a solution in an organic solvent to color organic solvents, hydrocarbon fuels, waxes, lubricants, plastics, and other hydrocarbon-based nonpolar materials for various applications like printing ink, stationery ink, wood stains, aluminum foil coloring, polyester and metals foils, glass, plastic and metal coatings, leather and plastic coloration/finishing, hot stamping foil coloring etc.

The present invention discloses a process for preparing Solvent Blue 67 dye. The process yields specifically a residue free Solvent Blue 67 dye for various applications. The present process prevents solvent from drying leading to clogging, and ensures high quality printing and coloring process for various applications like printing ink, stationery ink, wood stains, aluminum foil coloring, polyester & metals foils, glass, plastic & metal coatings, leather and plastic coloration/finishing, hot stamping foil coloring etc., for substrates like cans, bottles, metal, and paper etc.

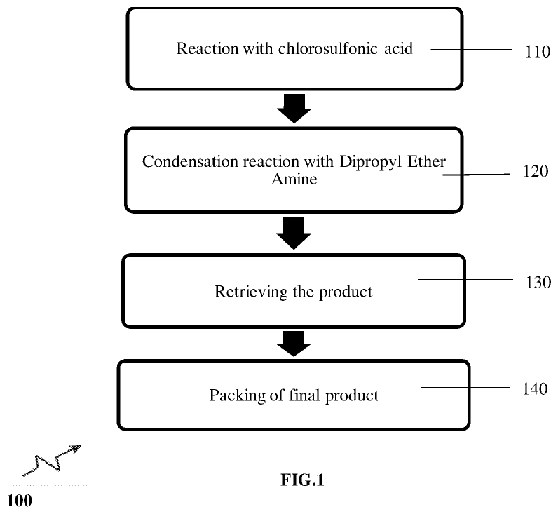

Now a preferred process of preparation of residue free Solvent Blue 67 dye in accordance with the present invention is disclosed. Referring to FIG. 1, the process 100 of the present invention includes a first stage of reaction with chlorosulfonic acid 110, a second stage of condensation reaction with alkyl/aryl/dialkyl/diaryl/hydroxylalkyl amine organocatalyst 120, a third stage of retrieving of the product 130, and a fourth stage of packing the final product 140.

In the present process 100, the first stage of reaction with chlorosulfonic acid 110 includes the steps of chlorosulfonation 201, followed by drowning 205, filtration 210 and homogenization 215.

In the first stage of reaction with chlorosulfonic acid 110, the first step of chlorosulfonation 201 includes the reaction of chlorosulphonation carried out in a vessel by reacting predefined amount of chlorosulfonic acid with predefined amount of crude copper phthalocyanine blue in presence of predefined amount of specified catalyst.

In the first stage 110, the second step of drowning 205 includes drowning of chlorosulfonated mass prepared in the chlorosulfonation step in a predefined solution present in a drowning vessel. The chlorosulphonated mass is drowned out by quenching the mass in ice water at a predefined temperature.

Further in the first stage 110, the third step of filtration 210 includes filtering the chlorosulfonated mass drowned in the step of drowning 205 followed by washing with ice water at a predefined pH.

In the first stage 110, the fourth step of homogenization 215 includes charging the wet cake of the step of filtration 210 in the presence of predefined amount of ice in a re-slurry mixer at a predefined temperature.

In the process 100 of the present invention, the second stage 120 includes the steps of condensation 220 followed by clarification 225, and filtration 230.

In the second stage 120, the first step of condensation 220 includes the condensation of homogenized chlorosulfonated slurry of step of homogenization 215 with a solution of predefined amount of alkyl/aryl/dialkyl/diaryl/hydroxylalkyl amine organocatalyst and a predefined amount of a predefined emulsifying agent in ice water. Further, the step of condensation 220 is carried out at a predefined temperature and pH in a vessel.

In the second stage 120, the second step of clarification 225 includes circulating the reaction mass obtained by the step of condensation 220 in a filter of predefined mesh size for a predefined temperature until the residue content is dropped below 40 PPM. In the second stage 120, the third step of filtration 230 includes filtering the clarified slurry obtained by the step of clarification 225 in a filter press to achieve a predefined conductivity followed by salt free filtered water.

In the process 100 of the present invention, the third stage 130 includes retrieving the product by the steps of spin flash drying 235 followed by air classifying 240 and sieving 245.

In the third stage 130, the first step of spin flash drying 235 includes drying of the press cake obtained in the step of filtration 230 by using turbo spin flash dryer. In the third stage 130, the second step of air classifying 240 includes passing the powder obtained in the step spin flash drying 235 through an air classified mill. In the third stage 130, the third step of sieving 245 includes sieving of the dry powder obtained in the step of air-classifying 240 over vibratory sieve fitted with a sieve of predefined size.

In the process 100 of the present invention, the fourth stage 140 includes the steps of vibratory separation 250 and the step of packing 255.

In the fourth stage 140, the first step of vibratory separation 250 includes separating the sieved powder obtained in the step of sieving 245 by subjecting to vibration platform for separating the powder in the layers based on differential density. In the fourth stage 140, the second step of packing 255 includes packaging of residue free powder of the product Solvent Blue 67 obtained in the step of vibratory separation 250.

In the first step of chlorosulfonation 201 of the first stage of reaction with chlorosulfonic acid 110, the predefined amount of chlorosulfonic acid is 1200 g to 1400 g, wherein the quality ratio of sulphuric anhydride to hydrogen chloride acid value is neither >2.291 nor <1.995. The predefined amount of crude copper phthalocyanine blue is 220 g to 320 g. The predefined catalyst is organic/inorganic acid chloride in a predefined amount of 250 g to 380 g. In this step, the degree of chlorosulfonation is checked on a double beam UV VIS spectrophotometer with a resolution of not above 2 nm.

In the second step of drowning 205 of the first stage of reaction with chlorosulfonic acid 110, the vessel receives 1000 L to 2000 L water through multimedia filter. The predefined solution includes softening agent, catalyst, oxidant, and binders. The ice water includes 4500 g to 6000 g ice cube made with residue free water in 3-4 lots. The step of drowning 205 is carried out through multi point jet device at predefined temperature between near subzero or zero.

In the step of filtration 210, the predefined pH is 0.5 to 5.0. In the step of homogenization 215, the predefined amount of ice is 800 g-1000 g. The homogenization is carried out at a predefined temperature between near subzero or zero.

In the step of condensation 220, the solution includes alkyl/aryl/dialkyl/diaryl/hydroxylalkyl amine organocatalyst in a predefined amount of 250 g to 400 g, and the predefined emulsifying agent is selected from Noigen, Neowet, Dainol, DKK, GMS, SLS and Linoxide, in a predefined amount of 5 g to 15 g. The predefined temperature for this step is near subzero or zero and the predefined pH is maintained at 8.0 to 10 by adding 5 to 25% solution of sodium bicarbonate.

In the step of clarification 225, the predefined mesh size of filter is 20 to 100 mesh, and the predefined temperature is 60° C. to 95° C. In the step of filtration 230, the clarified slurry is filtered to achieve a predefined conductivity of less than 200 μS. In the step of sieving 245, the vibratory sieve has a sieve of predefined size of 20 to 125 micron.

### EXAMPLES

Only a few examples and implementations are disclosed. Variations, modifications, and enhancements to the described examples and implementations and other implementations can be made based on what is disclosed.

Examples are set forth herein below and are illustrative of different amounts and types of reactants and reaction conditions that can be utilized in practicing the disclosure. It will be apparent, however, that the disclosure can be practiced with other amounts and types of reactants and reaction conditions than those used in the examples, and the resulting devices various different properties and uses in accordance with the disclosure above and as pointed out hereinafter.

### Example 1: Preparation of Residue Free Solvent Blue 67 Dye

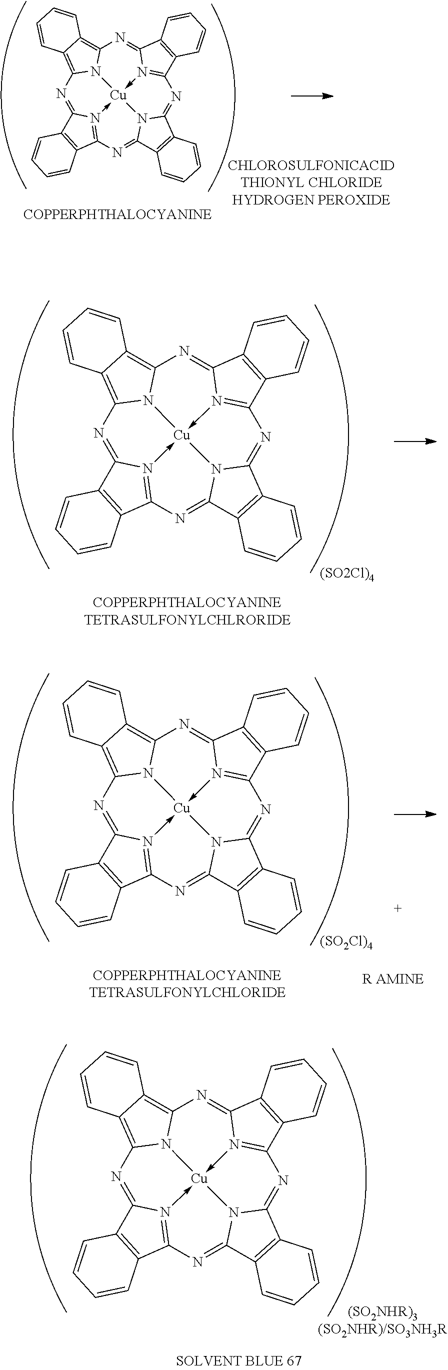

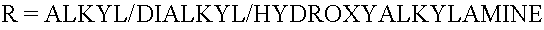

### Process of Preparation:

### 1. Step of Chlorosulfonation 201

In a vessel, 1200 g to 1400 g chlorosulfonic acid of quality ratio of sulphuric anhydride to hydrogen chloride acid value neither >2.291 nor <1.995 is added. The vessel is connected to column with dilute sodium hydroxide as absorbent to absorb the acid fumes. Further, 220 g to 320 g powder of crude copper phthalocyanine blue is added in the vessel through a magnetic grid of 8 to 20 magnets spaced not more than 5 cm apart. The reaction is carried out in the presence of 250 g to 380 g of charged acid chloride as catalyst. The temperature of the reaction mass is maintained between 5° C. to 30° C. for at least for 2 to 7 hours. Once complete dissolution is confirmed, then the reaction mass is heated with steam in jacket to a temperature of 80° C. to 110° C. and maintained for 1 to 5 hours. Further this is slowly heated to 110° C. to 135° C. Thereafter the degree of chlorosulfonation is checked on a double beam UV VIS spectrophotometer with resolution of not above 2 nm.

The absorption value obtained is found to be in the range of 0.6 to 0.85.

### 2. Step of Drowning 205

In the step of drowning 205, 1000 ml to 2000 ml of water is added through multimedia filter in the drowning vessel. It is charged with binders and peroxide, and 4500 g to 6000 g ice cubes made with residue free water in 3-4 lots added to the drowning vessel. The chlorosulphonated mass is drowned in the drowning vessel in 1 hr. to 5 hrs. through multi point jet device at a temperature between near subzero to zero.

### 3. Step of Filtration 210

In the step of filtration 210, the tight membrane filter press is set. Then the drowned chlorosulfonated mass received by drowning step 205 is filtered first as per standard procedure. Thereafter the wet cake is washed in filter press with water until a pH 0.5 to 5.0 of the filtrate is obtained. The filtrate is aerated well and squeezed to maximum till it does not drip, and then the cake is unloaded.

### 4. Step of Homogenization 215

In the step of homogenization 215, the filtered cake of chlorosulfonated mass is made into slurry mixer. The mixer is run at temperature not exceeding −2° C. to 6° C.

### 5. Step of Condensation 220

In the step of condensation 220, the condensation reaction is carried out. 5 g to 15 g Noigen, Neowet Dainol, DKK GMS, SLS and Linoxide is used as emulsifier and 250 g to 400 g dipropyl amine in residue free water is added under agitation to the homogenized chlorosulfonated slurry received from step of homogenization 215. The pH is maintained at 8.0 to 10 and the temperature is maintained at near subzero to zero. Further, the reaction mass is stirred continuously and heated to 25° C. to 60° C. and maintained at a pH 7.5 to 10.5 for 4 to 9 hrs. by adding 5-25% solution of sodium carbonate.

### 6. Step of Clarification 225

In the step of clarification 225, the reaction mass obtained by the step of condensation 220 is circulated in filter of 10 to 100 mesh size for up to 24 hrs. The cake is dried, and the residue content dropped below 40 PPM.

### 7. Step of Filtration 230

In the step of filtration 230, the clarified slurry obtained by the step of clarification 225 is filtered in filter press till the conductivity is less than 200 μS and then washed with salt free water.

### Step of Spin Flash Drying 235

In the step of spin flash drying 235, the press cake obtained in the step of filtration 230 is dried by using turbo spin flash dryer.

### 8. Step of Airclassifying 240

In the step of airclassifying 240, the powder obtained in the step spin flash drying 235 is passed through air classified mill.

### 9. Step of Sieving 245

In the step of sieving 245, the dry powder obtained in the step of airclassifying 240 is sieved over vibratory sieve fitted with 20 to 125 micron sieve.

### 10. Step of Vibratory Separation 250

In the step of vibratory separation 250, the sieved powder obtained in step of sieving 245 is separated by subjecting to vibration platform for separating the powder in the layers based on differential density.

### Step of Packing 255

In the step of packing 255, the residue free powder of Solvent Blue 67 obtained in the step of vibratory separation 250 is packed.

### Example 2: Preparation of Residue Free Solvent Blue 67 Dye

For the preparation of Solvent Blue 67, chlorosulfonation is carried out in a vessel by reacting chlorosulfonic acid with 300 g of crude copper phthalocyanine blue (CPC) in presence of acid chloride followed by the process of drowning, filtration, homogenization, condensation, clarification, filtration, spin flash drying, airclassifying and sieving to retrieve the final product. The final product obtained is 560 g to 600 g of Solvent Blue 67 with purity 100%+5% coloristic value. Further, the estimation of residue content is determined by filtration process of prepared Solvent Blue 67 dye using organic solvent and the weight of residue is calculated.

Result: The weight of residue obtained is >20 & <100 μg/g.

### Example 3: Estimation of Residue Content in Solvent Blue 67 Dye

An adequate quantity of Solvent Blue 67 of about 20 g to 60 g is dissolved in 50 ml to 150 ml of alkyl ester (or alkyl ketonic organic solvent) based on end process in a glass beaker. The beaker is closely covered to prevent evaporation, and the solution in it is stirred using a magnetic needle without spurting of the solution for about 45 to 60 minutes at 25° C. to 35° C. Thereafter, the solution is allowed to stand for 20 to 30 minutes.

The resultant dye solution is filtered through a filtration assembly. In the filtration assembly, pre-weighed stainless-steel sieve mesh of 20 to 50 micron pore size and diameter of about 40 mm is fitted in the tailor made holder and PTFE gaskets tightened with the inbuilt screws are provided on both the sides of the circular mesh. The residue left in the beaker is quantitatively transferred to the filter using 20 ml to 30 ml of alkyl ester (or alkyl ketonic organic solvent) and the filtrate is further washed with 15 to 25 ml of the same solvent to make it colour free. The mesh is removed carefully and dried at 40° C. to 50° C. in an oven and weighed. The weight of residue is calculated as weights of before and after filtration and expressed in PPM.

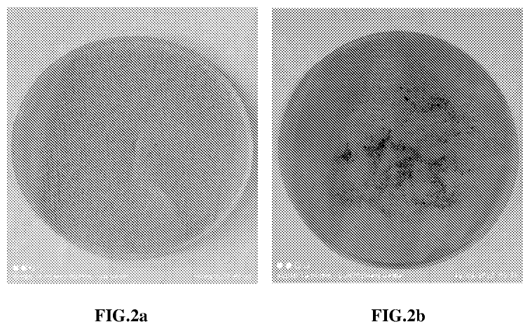

Further, an estimation of residue content in Solvent Blue 67 is compared using reference sample available in the market. The comparison of the residue of solvent blue 67 prepared by the process of the present invention and the conventional reference sample of Solvent Blue 67 available in market is as shown in FIGS. 2a and 2b.

Observation: FIG. 2b of conventional reference sample of Solvent Blue 67 shows the presence of residue, while FIG. 2a of solvent blue prepared by process of the present invention Solvent Blue 67 does not show presence of any amount of residue in it.

Advantageously, the process of the present invention 100 for preparing Solvent Blue 67 dye yields a residue free Solvent Blue 67 dye. The residue free Solvent Blue 67 dye prepared from the process of the present invention 100 ensures high quality printing, coloring, and coating processes as solvent drying that leads to clogging is prevented, and the molecules of Solvent Blue 67 do not clog during application. The Solvent Blue 67 of present invention is used as a solution in an organic solvent to color organic solvents, hydrocarbon fuels, waxes, lubricants, plastics, and other hydrocarbon-based nonpolar materials for various applications like printing ink, stationery ink, wood stains, aluminum foil coloring, polyester and metals foils, glass, plastic & metal coatings, leather & plastic coloration/finishing, hot stamping foil coloring, etc.

The embodiments were chosen and described in order to best explain the principles of the present invention and its practical application, to thereby enable others, skilled in the art to best utilize the present invention and various embodiments with various modifications as are suited to the particular use contemplated.

It is understood that various omission and substitutions of equivalents are contemplated as circumstance may suggest or render expedient, but such are intended to cover the application or implementation without departing from the scope of the present invention.

1. A process 100 of preparation of residue free Solvent Blue 67 dye comprising:
a. a first stage of reaction with chlorosulfonic acid 110 including chlorosulfonation 201 followed by drowning 205, filtration 210 and homogenization 215;
b. a second stage of condensation reaction with alkyl/aryl/dialkyl/diaryl/hydroxylalkyl amine organocatalyst 120 including condensation 220, followed by clarification 225 and filtration 230;
c. a third stage of retrieving of the product 130 including spin flash drying 235 followed by air classifying 240 and sieving 245; and
d. a fourth stage of packing of final product 140 including vibratory separation 250 followed by packing 255.

2. The process 100 of preparation of residue free Solvent Blue 67 dye as claimed in claim 1, wherein the first stage of reaction with chlorosulfonic acid 110 including chlorosulfonation 201 followed by drowning 205, filtration 210 and homogenization 215 wherein
a. the step of chlorosulphonation 201 reaction being carried out in a vessel by reacting predefined amount of chlorosulfonic acid with predefined amount of crude copper phthalocyanine blue in presence of predefined amount of specified catalyst;
b. the step of drowning 205 being carried out in a drowning vessel of chlorosulfonated mass prepared in the step of chlorosulfonation 201 in a predefined solution followed by quenching the drowning mass in ice water at a predefined temperature;
c. the step of filtration 210 being carried out by filtering the chlorosulfonated mass drowned in the drowning 205 followed by washing with ice water at predefined pH; and
d. the step of homogenization 215 being carried out by charging the wet cake of the filtration 210 in the presence of predefined amount of ice in a re-slurry mixer at predefined temperature.

3. The first stage of reaction with chlorosulfonic acid 110 as claimed in claim 2 wherein,
a. in the step of chlorosulphonation 201, the predefined amount of chlorosulfonic acid being 1200 g to 1400 g, the predefined amount of crude copper phthalocyanine blue being 220 g to 320 g, and the predefined catalyst being acid chloride in an amount of 250 g to 380 g;
b. in the step of drowning 205, the predefined solution being prepared from binders and peroxide, and the quenching being carried out at a predefined temperature between near subzero to zero;
c. in the step of filtration 210, the predefined pH being 0.5 to 5.0; and
d. in the step of homogenization 215, predefined amount of ice being 800 g-1000 g and the predefined temperature being between near subzero to zero.

4. The process 100 as claimed in claim 1, wherein the second stage of condensation reaction with alkyl/aryl/dialkyl/diaryl/hydroxylalkyl amine organocatalyst 120 including condensation 220 followed by clarification 225 and filtration 230 wherein,
a. the step of condensation 220 being carried out by condensing chlorosulfonated slurry of homogenization 215 with solution of predefined amount of alkyl/aryl/dialkyl/diaryl/hydroxylalkyl amine organocatalyst and predefined amount of a predefined emulsifying agent in ice water at a predefined temperature and pH;
b. the step of clarification 225 being carried out by circulating the reaction mass of condensation 220 in a filter of predefined mesh size for a predefined temperature; and
c. the step of filtration 230 being carried out by filtering the clarified slurry from the step of clarification 225 to attain a predefined conductivity.

5. The second stage of condensation reaction with alkyl/aryl/dialkyl/diaryl/hydroxylalkyl amine organocatalyst 120 as claimed in claim 4 wherein
a. in the step of condensation 220, the predefined amount of solution of alkyl/aryl/dialkyl/diaryl/hydroxylalkyl amine organocatalyst being 250 g to 400 g and the predefined emulsifying agent being selected from Noigen, Neowet Dainol, DKK GMS, SLS and Linoxide in a predefined amount of 5 g to 15 g in ice water at a predefined temperature between near subzero to zero and predefined pH being maintained at 8.0 to 10;
b. in the step of clarification 225, the predefined mesh size of filter being 20 to 100 mesh and the predefined temperature being 60° C. to 95° C.; and
c. in the step of filtration 230, the clarified slurry being filtered to achieve a predefined conductivity of less than 200 μS.

6. The process 100 as claimed in claim 1, wherein the third stage of retrieving of the product 130 includes spin flash drying 235 followed by air classifying 240 and sieving 245 wherein,
a. the step of spin flash drying 235 being carried out by drying the press cake obtained in filtration 230 by using turbo spin flash dryer;
b. the step of air classifying 240 being carried out by passing the powder obtained in spin flash drying 235 through air classified mill; and
c. the step of sieving 245 being carried out by sieving of the dry powder obtained in air-classifying 240 over vibratory sieve fitted with sieve of predefined size.

7. The third stage of retrieving of the product 130 as claimed in claim 6 wherein, in the step of sieving 245, the predefined size of the vibratory sieve being 20 to 125 micron.

8. The process 100 as claimed in claim 1, wherein the fourth stage of packing of final product 140 includes vibratory separation 250 followed by packing 255 wherein,
a. The step of vibratory separation 250 being carried out by separating the sieved powder obtained in sieving 245 by subjecting to vibration platform for separating the powder in the layers based on differential density; and
b. The step of packing 255 being carried out by packaging the residue free powder of the product Solvent Blue 67 obtained in vibratory separation 250.
